(19) United States
(12) Patent Application Publication
(10) Pub. No.: US 2025/0199543 A1
(43) Pub. Date: Jun. 19, 2025

(54) POWER MANAGEMENT FOR A ROBOTIC DEVICE

(71) Applicant: Boston Dynamics, Inc., Waltham, MA (US)

(72) Inventors: Matthew Kelly, Carlisle, MA (US); Robin Deits, Lexington, MA (US); Jared DiCarlo, Lincoln, MA (US)

(21) Appl. No.: 18/541,021

(22) Filed: Dec. 15, 2023

(51) Int. Cl. G05D 1/646; B60L 15/20; B62D 57/032

(52) U.S. Cl. CPC G05D 1/646; B60L 15/20; B62D 57/032

(57) ABSTRACT

Methods and apparatus for determining a control strategy for controlling a robot based on power limits of the robot are provided. The method includes determining, by a computing device, motor control information for a plurality of motors associated with a plurality of joints of the robot, the motor control information being determined based, at least in part, on a robot trajectory to achieve a desired behavior and power limit information associated with a power system of the robot, and controlling the plurality of motors associated with the plurality of joints of the robot based, at least in part, on the motor control information.

### TECHNICAL FIELD

This disclosure relates generally to robotics, and more specifically to systems, methods and apparatuses for managing power associated with operation of components of robotic devices.

### BACKGROUND

Mobile robots that include joints actuated with electric motors may be capable of consuming or generating more power than the robot's power system (e.g., battery) can handle at any particular point in time. Requesting more power than the power system can provide or receive may result in damage to the electrical system of the robot (e.g., due to severe voltage drops or excess current regeneration into the power system). Some existing robot systems address such limitations of their power systems by determining whether the total power requested is greater than the capabilities of the power system and equally (or near equally) scaling down the current provided to each of the motors in the system to ensure the total power requested is within the power budget of the power system.

### SUMMARY

Multiple-degree of freedom (multi-dof) mobile robots may include a plurality of joints, each with its own electric motor. Each of the motors has a maximum amount of power that can be put through it based on the characteristics of the motor (e.g., due to current limits and/or voltage limits). However, the power system (e.g., battery system) of the mobile robot also has limits, such that it typically cannot simultaneously provide maximum current to all of the electric motors without causing damage to the electrical system of the robot. Some existing techniques for managing power associated with electric motors of a mobile robot limit each motor to less than its capabilities (e.g., by non-selectively reducing power to all of the motors) to ensure that the requested power is within the overall power budget of the robot. Such techniques may result in unexpected and/or undesired movements and/or behaviors of the robot, such as the robot falling over.

The inventors have recognized and appreciated that such techniques may be improved by taking the power limits of the individual motors and the overall power budget of the power system of the robot into account when determining the individual joint torques to be applied at the joints to achieve a desired behavior of the robot. To this end, some embodiments of the present disclosure are directed to techniques for intelligently trading off costs associated with providing power to different electric motors of a robot by taking into consideration the power limits of the power system of the robot when determining a control strategy for performing a desired behavior of the robot.

In one aspect, the invention features a controller for a robot. The robot includes a plurality of joints. The controller is programmed to execute a plurality of instructions that, when executed by a processor of a computing device perform a method. The method includes determining, by the computing device, motor control information for a plurality of motors associated with the plurality of joints, the motor control information being based, at least in part, on a robot trajectory to achieve a desired behavior and power limit information associated with a power system of the robot, and controlling the plurality of motors associated with the plurality of joints of the robot based, at least in part, on the motor control information.

In some embodiments, the method further includes receiving the robot trajectory, and determining the motor control information comprises performing an optimization based on the robot trajectory, wherein the optimization includes a power limit constraint based on the power limit information. In some embodiments, performing an optimization includes minimizing a cost function associated with at least one objective, wherein minimizing the cost function is subject to one or more constraints including the power limit constraint. In some embodiments, the at least one objective includes a balance objective for the robot. In some embodiments, the one or more constraints includes limits of each of the plurality of motors. In some embodiments, the one or more constraints includes environmental constraints.

In some embodiments, the motor control information includes instantaneous motor currents for each of the plurality of motors. In some embodiments, determining motor control information comprises determining a plurality of joint torques for the plurality of joints. In some embodiments, the method further includes determining based, at least in part, on the power limit information associated with a power system of the robot, the robot trajectory. In some embodiments, determining the motor control information comprises performing an optimization based on the robot trajectory, wherein the optimization includes a power limit constraint based on the power limit information. In some embodiments, the robot trajectory includes a plurality of forces that the robot should apply on its environment to achieve the desired behavior, and a plurality of accelerations for the plurality of joints. In some embodiments, the controller is a whole-body controller and the plurality of joints include each joint of the robot that is associated with one or more of the plurality of motors.

In some embodiments, the power system of the robot is an electric power system including at least one battery, and the motor control information includes motor currents for each of the plurality of motors. In some embodiments, the power limit information includes power that can be provided by the at least one battery and/or power that can be consumed by the at least one battery during recharging of the at least one battery.

In one aspect, the invention features a robot. The robot includes a plurality of joints, a plurality of motors associated with the plurality of joints, a power system configured to provide power to the plurality of motors, data processing hardware, and memory hardware in communication with the data processing hardware. The memory hardware stores instructions that when executed on the data processing hardware cause the data processing hardware to perform operations. The operations include determining motor control information for the plurality of motors associated with the plurality of joints, the motor control information being based, at least in part, on a robot trajectory to achieve a desired behavior and power limit information associated with the power system of the robot, and controlling the plurality of motors associated with the plurality of joints of the robot based, at least in part, on the motor control information.

In some embodiments, the operations further include receiving the robot trajectory, wherein determining the motor control information comprises performing an optimization based on the robot trajectory, and the optimization includes a power limit constraint based on the power limit information. In some embodiments, performing an optimization includes minimizing a cost function associated with at least one objective, wherein minimizing the cost function is subject to one or more constraints including the power limit constraint. In some embodiments, the at least one objective includes a balance objective for the robot. In some embodiments, the one or more constraints includes limits of each of the plurality of motors. In some embodiments, the one or more constraints includes environmental constraints.

In some embodiments, the motor control information includes instantaneous motor currents for each of the plurality of motors. In some embodiments, determining motor control information comprises determining a plurality of joint torques for the plurality of joints. In some embodiments, the operations further include determining based, at least in part, on the power limit information associated with a power system of the robot, the robot trajectory.

In some embodiments, determining the motor control information comprises performing an optimization based on the robot trajectory, and the optimization includes a power limit constraint based on the power limit information. In some embodiments, the robot trajectory includes a plurality of forces that the robot should apply on its environment to achieve the desired behavior, and a plurality of accelerations for the plurality of joints. In some embodiments, the robot trajectory is a whole-body robot trajectory. In some embodiments, the power system is an electric power system including at least one battery, and the motor control information includes motor currents for each of the plurality of motors. In some embodiments, the power limit information includes power that can be provided by the at least one battery and/or power that can be consumed by the at least one battery during recharging of the at least one battery.

In one aspect, the invention features a computer-implemented method. The method includes determining, by a computing system of a robot, motor control information for a plurality of motors associated with a plurality of joints the robot, the motor control information being based, at least in part, on a robot trajectory to achieve a desired behavior and power limit information associated with a power system of the robot, and controlling the plurality of motors associated with the plurality of joints of the robot based, at least in part, on the motor control information.

In some embodiments, the method further includes receiving the robot trajectory, determining the motor control information comprises performing an optimization based on the robot trajectory, and the optimization includes a power limit constraint based on the power limit information. In some embodiments, performing an optimization includes minimizing a cost function associated with at least one objective, and minimizing the cost function is subject to one or more constraints including the power limit constraint. In some embodiments, the at least one objective includes a balance objective for the robot. In some embodiments, the one or more constraints includes limits of each of the plurality of motors. In some embodiments, the one or more constraints includes environmental constraints.

In some embodiments, the motor control information includes instantaneous motor currents for each of the plurality of motors. In some embodiments, determining motor control information comprises determining a plurality of joint torques for the plurality of joints. In some embodiments, the method further includes determining based, at least in part, on the power limit information associated with a power system of the robot, the robot trajectory.

In some embodiments, determining the motor control information comprises performing an optimization based on the robot trajectory, wherein the optimization includes a power limit constraint based on the power limit information. In some embodiments, the robot trajectory includes a plurality of forces that the robot should apply on its environment to achieve the desired behavior, and a plurality of accelerations for the plurality of joints. In some embodiments, the robot trajectory is a whole body robot trajectory. In some embodiments, the power system of the robot is an electric power system including at least one battery, and the motor control information includes motor currents for each of the plurality of motors. In some embodiments, the power limit information includes power that can be provided by the at least one battery and/or power that can be consumed by the at least one battery during recharging of the at least one battery.

In one aspect, the invention features a controller for a robot. The robot includes a plurality of joints. The controller is programmed to execute a plurality of instructions that, when executed by a processor of a computing device, perform a method. The method includes performing, by the computing device, a first optimization to determine a future robot trajectory to achieve a desired behavior, performing, by the computing device, a second optimization based on the future robot trajectory and power limit information associated with a power system of the robot to determine motor control information, and controlling a plurality of motors associated with the plurality of joints of the robot based, at least in part, on the motor control information.

In some embodiments, performing the first optimization comprises constraining the first optimization based, at least in part, on the power limit information. In some embodiments, performing the second optimization based on the power limit information comprises constraining the second optimization based, at least in part, on the power limit information. In some embodiments, constraining the second optimization based, at least in part, on the power limit information comprises constraining the second optimization based on positive work and negative work associated with the robot when the robot performs the desired behavior.

In some embodiments, the motor control information includes instantaneous motor currents for each of the plurality of motors. In some embodiments, determining motor control information comprises determining a plurality of joint torques for the plurality of joints. In some embodiments, the controller is a whole-body controller and the plurality of joints include each joint of the robot that is associated with one or more of the plurality of motors. In some embodiments, the power system of the robot is an electric power system including at least one battery, and the motor control information includes motor currents for each of the plurality of motors. In some embodiments, the future robot trajectory is determined over a time horizon of 1-2 seconds. In some embodiments, the motor control information comprises instantaneous motor control information.

In one aspect, the invention features a robot. The robot includes a plurality of joints, a plurality of motors associated with the plurality of joints, a power system configured to provide power to the plurality of motors, data processing hardware, and memory hardware in communication with the data processing hardware, the memory hardware storing instructions that when executed on the data processing hardware cause the data processing hardware to perform operations. The operations include performing a first optimization to determine a future robot trajectory to achieve a desired behavior, performing a second optimization based on the future robot trajectory and power limit information associated with the power system of the robot to determine motor control information, and controlling the plurality of motors associated with the plurality of joints of the robot based, at least in part, on the motor control information.

In some embodiments, performing the first optimization comprises constraining the first optimization based, at least in part, on the power limit information. In some embodiments, performing the second optimization based on the power limit information comprises constraining the second optimization based, at least in part, on the power limit information. In some embodiments, constraining the second optimization based, at least in part, on the power limit information comprises constraining the second optimization based on positive work and negative work associated with the robot when the robot performs the desired behavior.

In some embodiments, the motor control information includes instantaneous motor currents for each of the plurality of motors. In some embodiments, determining motor control information comprises determining a plurality of joint torques for the plurality of joints. In some embodiments, the plurality of joints include each joint of the robot that is associated with one or more of the plurality of motors. In some embodiments, the power system of the robot is an electric power system including at least one battery, and the motor control information includes motor currents for each of the plurality of motors. In some embodiments, the future robot trajectory is determined over a time horizon of 1-2 seconds. In some embodiments, the motor control information comprises instantaneous motor control information.

In one aspect, the invention features a computer-implemented method. The method includes performing, by a computing device of a robot, a first optimization to determine a future robot trajectory to achieve a desired behavior, performing, by the computing device, a second optimization based on the future robot trajectory and power limit information associated with a power system of the robot to determine motor control information, and controlling a plurality of motors associated with a plurality of joints of the robot based, at least in part, on the motor control information.

In some embodiments, performing the first optimization comprises constraining the first optimization based, at least in part, on the power limit information. In some embodiments, performing the second optimization based on the power limit information comprises constraining the second optimization based, at least in part, on the power limit information. In some embodiments, constraining the second optimization based, at least in part, on the power limit information comprises constraining the second optimization based on positive work and negative work associated with the robot when the robot performs the desired behavior.

In some embodiments, the motor control information includes instantaneous motor currents for each of the plurality of motors. In some embodiments, determining motor control information comprises determining a plurality of joint torques for the plurality of joints. In some embodiments, the plurality of joints include each joint of the robot that is associated with one or more of the plurality of motors. In some embodiments, the power system of the robot is an electric power system including at least one battery, and the motor control information includes motor currents for each of the plurality of motors. In some embodiments, the future robot trajectory is determined over a time horizon of 1-2 seconds. In some embodiments, the motor control information comprises instantaneous motor control information.

In one aspect, the invention features a controller for a robot. The robot includes a plurality of joints. The controller is programmed to execute a plurality of instructions that, when executed by a processor of a computing device, perform a method. The method includes generating regenerative power in a first set of motors of the robot, determining, by the computing device, whether an amount of the regenerative power exceeds a charge limit of at least one power source of the robot, and when it is determined that the amount of regenerative power exceeds the charge limit of the at least one power source of the robot, distributing at least a first portion of the regenerative power to a second set of motors of the robot for dissipating the at least a first portion of the regenerative power, wherein the second set of motors of the robot include at least one motor not included in the first set of motors.

In some embodiments, when it is determined that the amount of regenerative power exceeds the charge limit of the at least one power source of the robot, charging the at least one power source of the robot with at least a second portion of the regenerative power. In some embodiments, the at least a first portion of the regenerative power includes all of the regenerative power. In some embodiments, when it is determined that the amount of regenerative power does not exceed the charge limit of the at least one power source of the robot, charging the at least one power source of the robot with the regenerative power. In some embodiments, the method further includes determining a control strategy for controlling a plurality of motors of the robot associated with the plurality of joints to perform a desired behavior, and determining the control strategy comprises selecting the second set of motors.

In one aspect, the invention features a robot. The robot includes a plurality of joints, and a plurality of motors associated with the plurality of joints. The plurality of motors includes a first set of motors and a second set of motors, wherein the second set of motors include at least one motor not included in the first set of motors. The robot further includes a power system configured to provide power to the plurality of motors, the power system including at least one power source. The robot further includes data processing hardware, and memory hardware in communication with the data processing hardware, the memory hardware storing instructions that when executed on the data processing hardware cause the data processing hardware to perform operations. The operations include generating regenerative power in the first set of motors, determining whether an amount of the regenerative power exceeds a charge limit of the at least one power source, and when it is determined that the amount of regenerative power exceeds the charge limit of the at least one power source, distributing at least a first portion of the regenerative power to the second set of motors of the robot for dissipating the at least a first portion of the regenerative power.

In some embodiments, when it is determined that the amount of regenerative power exceeds the charge limit of the at least one power source, charging the at least one power source with at least a second portion of the regenerative power. In some embodiments, the at least a first portion of the regenerative power includes all of the regenerative power. In some embodiments, when it is determined that the amount of regenerative power does not exceed the charge limit of the at least one power source, charging the at least one power source with the regenerative power. In some embodiments, the operations further include determining a control strategy for controlling a plurality of motors of the robot associated with the plurality of joints to perform a desired behavior, and determining the control strategy comprises selecting the second set of motors.

In one aspect, the invention features a computer-implemented method. The method includes generating regenerative power in a first set of motors of a robot, determining, by a computing device, whether an amount of the regenerative power exceeds a charge limit of at least one power source of the robot, and when it is determined that the amount of regenerative power exceeds the charge limit of the at least one power source of the robot, distributing at least a first portion of the regenerative power to a second set of motors of the robot for dissipating the at least a first portion of the regenerative power, wherein the second set of motors of the robot include at least one motor not included in the first set of motors.

In some embodiments, when it is determined that the amount of regenerative power exceeds the charge limit of the at least one power source of the robot, charging the at least one power source of the robot with at least a second portion of the regenerative power. In some embodiments, the at least a first portion of the regenerative power includes all of the regenerative power. In some embodiments, when it is determined that the amount of regenerative power does not exceed the charge limit of the at least one power source of the robot, charging the at least one power source of the robot with the regenerative power. In some embodiments, the method further includes determining a control strategy for controlling a plurality of motors associated with a plurality of joints of the robot to perform a desired behavior, and determining the control strategy comprises selecting the second set of motors.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 illustrates a configuration of a robotic system, in accordance with an example implementation.

FIG. 2 illustrates a quadruped robot, in accordance with an example implementation.

FIG. 3 illustrates a biped robot, in accordance with another example implementation.

FIG. 4 schematically illustrates a power system of a robot, in accordance with an example implementation.

FIG. 5 is a block diagram including components of an example implementation of a control system for a robot.

FIG. 6A is a block diagram including components for another example implementation of a control system for a robot.

FIG. 6B is a block diagram including components for another example implementation of a control system for a robot.

FIG. 7 is a flowchart of a process for determining a control strategy for a robot, in accordance with an example implementation.

FIG. 8 is a flowchart of a process for determining a control strategy for a robot, in accordance with another example implementation.

FIG. 9 is a flowchart of a process for managing regenerative power according to a control strategy for a robot, in accordance with an example implementation.

Like reference symbols in the various drawings indicate like elements.

### DETAILED DESCRIPTION

In an electric-powered robot, each joint of the robot may be associated with its own electric motor that can be actuated to move the joint. Each of the motors has a maximum amount of power that can be provided to drive it (e.g., limits on current, voltage, simultaneous current, simultaneous voltage). Mobile electric-powered robots may include a power source (e.g., one or more batteries) that provides requested power via a power bus to the electric motors of the robot in response to motor control information. In addition to limiting the amount of power that can be provided to individual motors at any one point in time, the overall power budget of the power system of the robot limits how much available power can be provided to the plurality of motors from the power source without damaging the electrical components of the robot (e.g., the battery, the wiring coupling the battery to the motors, etc.).

As described above, some conventional techniques for ensuring that the requested power fits within the power budget of the power system of a robot may involve generating a control strategy without considering the power requirements of the control strategy, then limiting (e.g., non-selectively) the power provided to each of the motors included in the control strategy when it is determined that the total requested power exceeds the power limits of the robot. However, such techniques limit each motor to less than its capabilities in a way that may result in unpredictable or undesirable behavior of the robot (e.g., the robot may lose balance and fall down). Some embodiments of the present disclosure integrate the limit on total power (e.g., the total current that can be produced from the power source(s) of the robot) and apply this total power system limit as a constraint in a process that determines the control strategy for performing a desired behavior. For example, the total power capability of the power system may be used to constrain an optimization process that determines torques for individual motors associated with joints of the robot. By applying a constraint to the optimization when selecting the individual motor torques, the optimization process can make intelligent decisions about how to trade off power provided to motors at different joints. Such an approach allows for, for example, coordination of torque limits across the entire robot, management of the total power bus constraints, distribution of regeneration commands across idle motors, and determination of a control strategy that takes into consideration the effect that power limits have on robot behavior.

The following detailed description describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

### I. Example Robotic Systems

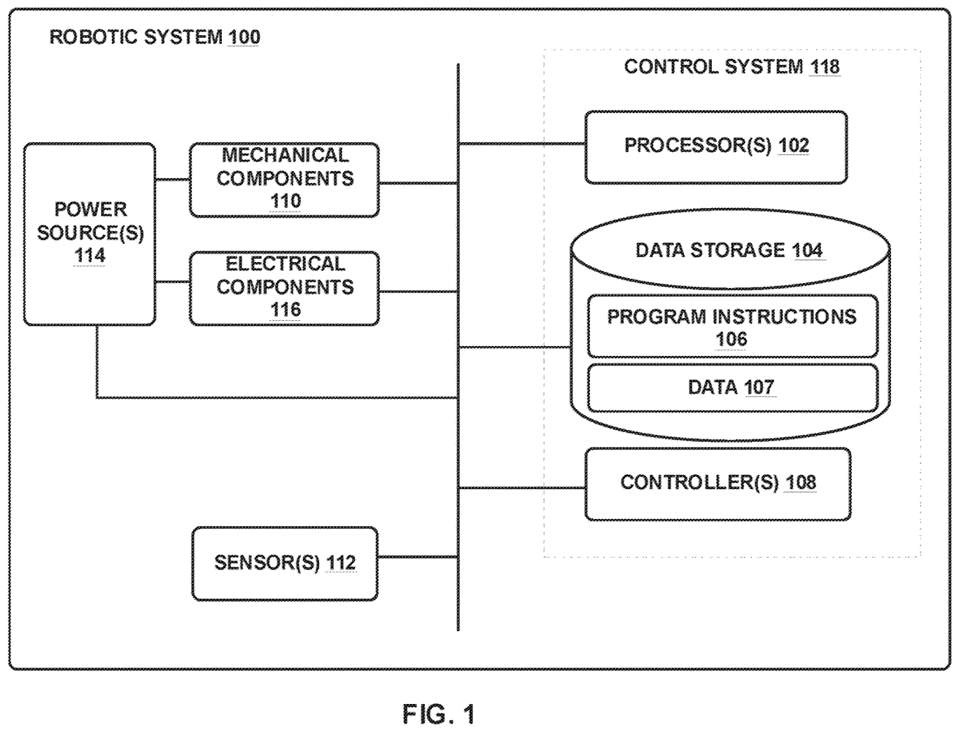

FIG. 1 illustrates an example configuration of a robotic system that may be used in connection with the implementations described herein. The robotic system 100 may be configured to operate autonomously, semi-autonomously, and/or using directions provided by user(s). The robotic system 100 may be implemented in various forms, such as a biped robot, quadruped robot, or some other arrangement. Furthermore, the robotic system 100 may also be referred to as a robot, robotic device, or mobile robot, among other designations, and could be part of an exoskeleton or human assisting device.

As shown in FIG. 1, the robotic system 100 may include processor(s) 102, data storage 104, and controller(s) 108, which together may be part of a control system 118. The robotic system 100 may also include sensor(s) 112, power source(s) 114, mechanical components 110, and electrical components 116. Nonetheless, the robotic system 100 is shown for illustrative purposes, and may include more or fewer components. The various components of robotic system 100 may be connected in any manner, including wired or wireless connections. Further, in some examples, components of the robotic system 100 may be distributed among multiple physical entities rather than a single physical entity. Other example illustrations of robotic system 100 may exist as well.

Processor(s) 102 may operate as one or more general-purpose hardware processors or special purpose hardware processors (e.g., digital signal processors, application specific integrated circuits, etc.). The processor(s) 102 may be configured to execute computer-readable program instructions 106, and manipulate data 107, both of which are stored in the data storage 104. The processor(s) 102 may also directly or indirectly interact with other components of the robotic system 100, such as sensor(s) 112, power source(s) 114, mechanical components 110, and/or electrical components 116.

The data storage 104 may be one or more types of hardware memory. For example, the data storage 104 may include or take the form of one or more computer-readable storage media that can be read or accessed by processor(s) 102. The one or more computer-readable storage media can include volatile and/or non-volatile storage components, such as optical, magnetic, organic, or another type of memory or storage, which can be integrated in whole or in part with processor(s) 102. In some implementations, the data storage 104 can be a single physical device. In other implementations, the data storage 104 can be implemented using two or more physical devices, which may communicate with one another via wired or wireless communication. As noted previously, the data storage 104 may include the computer-readable program instructions 106 and the data 107. The data 107 may be any type of data, such as configuration data, sensor data, and/or diagnostic data, among other possibilities.

The controller 108 may include one or more electrical circuits, units of digital logic, computer chips, and/or microprocessors that are configured to (perhaps among other tasks), interface between any combination of the mechanical components 110, the sensor(s) 112, the power source(s) 114, the electrical components 116, the control system 118, and/or a user of the robotic system 100. In some implementations, the controller 108 may be a purpose-built embedded device for performing specific operations with one or more subsystems of the robotic system 100.

The control system 118 may monitor and physically change the operating conditions of the robotic system 100. In doing so, the control system 118 may serve as a link between portions of the robotic system 100, such as between mechanical components 110 and/or electrical components 116. In some instances, the control system 118 may serve as an interface between the robotic system 100 and another computing device.

Further, the control system 118 may serve as an interface between the robotic system 100 and a user. For instance, the control system 118 may include various components for communicating with the robotic system 100, including a joystick, buttons, and/or ports, etc. The example interfaces and communications noted above may be implemented via a wired or wireless connection, or both. The control system 118 may perform other operations for the robotic system 100 as well.

During operation, the control system 118 may communicate with other systems of the robotic system 100 via wired or wireless connections, and may further be configured to communicate with one or more users of the robot. As one possible illustration, the control system 118 may receive an input (e.g., from a user or from another robot) indicating an instruction to perform a particular gait in a particular direction, and at a particular speed. A gait is a pattern of movement of the limbs of an animal, robot, or other mechanical structure.

Based on this input, the control system 118 may perform operations to cause the robotic system 100 to move according to the requested gait. As another illustration, a control system may receive an input indicating an instruction to move to a particular geographical location. In response, the control system 118 (perhaps with the assistance of other components or systems) may determine a direction, speed, and/or gait based on the environment through which the robotic system 100 is moving en route to the geographical location.

Operations of the control system 118 may be carried out by the processor(s) 102. Alternatively, these operations may be carried out by the controller 108, or a combination of the processor(s) 102 and the controller 108. In some implementations, the control system 118 may partially or wholly reside on a device other than the robotic system 100, and therefore may at least in part control the robotic system 100 remotely.

Mechanical components 110 represent hardware of the robotic system 100 that may enable the robotic system 100 to perform physical operations. As a few examples, the robotic system 100 may include physical members such as leg(s), arm(s), and/or wheel(s). The physical members or other parts of robotic system 100 may further include actuators arranged to move the physical members in relation to one another. The robotic system 100 may also include one or more structured bodies for housing the control system 118 and/or other components, and may further include other types of mechanical components. The particular mechanical components 110 used in a given robot may vary based on the design of the robot, and may also be based on the operations and/or tasks the robot may be configured to perform.

In some examples, the mechanical components 110 may include one or more removable components. The robotic system 100 may be configured to add and/or remove such removable components, which may involve assistance from a user and/or another robot. For example, the robotic system 100 may be configured with removable arms, hands, feet, and/or legs, so that these appendages can be replaced or changed as needed or desired. In some implementations, the robotic system 100 may include one or more removable and/or replaceable battery units or sensors. Other types of removable components may be included within some implementations.

The robotic system 100 may include sensor(s) 112 arranged to sense aspects of the robotic system 100. The sensor(s) 112 may include one or more force sensors, torque sensors, velocity sensors, acceleration sensors, position sensors, proximity sensors, motion sensors, location sensors, load sensors, temperature sensors, touch sensors, depth sensors, ultrasonic range sensors, infrared sensors, object sensors, and/or cameras, among other possibilities. Within some examples, the robotic system 100 may be configured to receive sensor data from sensors that are physically separated from the robot (e.g., sensors that are positioned on other robots or located within the environment in which the robot is operating).

The sensor(s) 112 may provide sensor data to the processor(s) 102 (perhaps by way of data 107) to allow for interaction of the robotic system 100 with its environment, as well as monitoring of the operation of the robotic system 100. The sensor data may be used in evaluation of various factors for activation, movement, and deactivation of mechanical components 110 and electrical components 116 by control system 118. For example, the sensor(s) 112 may capture data corresponding to the terrain of the environment or location of nearby objects, which may assist with environment recognition and navigation. In an example configuration, sensor(s) 112 may include RADAR (e.g., for long-range object detection, distance determination, and/or speed determination), LIDAR (e.g., for short-range object detection, distance determination, and/or speed determination), SONAR (e.g., for underwater object detection, distance determination, and/or speed determination), VICON® (e.g., for motion capture), one or more cameras (e.g., stereoscopic cameras for 3D vision), a global positioning system (GPS) transceiver, and/or other sensors for capturing information of the environment in which the robotic system 100 is operating. The sensor(s) 112 may monitor the environment in real time, and detect obstacles, elements of the terrain, weather conditions, temperature, and/or other aspects of the environment.

Further, the robotic system 100 may include sensor(s) 112 configured to receive information indicative of the state of the robotic system 100, including sensor(s) 112 that may monitor the state of the various components of the robotic system 100. The sensor(s) 112 may measure activity of systems of the robotic system 100 and receive information based on the operation of the various features of the robotic system 100, such as the operation of extendable legs, arms, or other mechanical and/or electrical features of the robotic system 100. The data provided by the sensor(s) 112 may enable the control system 118 to determine errors in operation as well as monitor overall operation of components of the robotic system 100.

As an example, the robotic system 100 may use force sensors to measure load on various components of the robotic system 100. In some implementations, the robotic system 100 may include one or more force sensors on an arm or a leg to measure the load on the actuators that move one or more members of the arm or leg. As another example, the robotic system 100 may use one or more position sensors to sense the position of the actuators of the robotic system. For instance, such position sensors may sense states of extension, retraction, or rotation of the actuators on arms or legs.

As another example, the sensor(s) 112 may include one or more velocity and/or acceleration sensors. For instance, the sensor(s) 112 may include an inertial measurement unit (IMU). The IMU may sense velocity and acceleration in the world frame, with respect to the gravity vector. The velocity and acceleration sensed by the IMU may then be translated to that of the robotic system 100 based on the location of the IMU in the robotic system 100 and the kinematics of the robotic system 100.

The robotic system 100 may include other types of sensors not explicitly discussed herein. Additionally or alternatively, the robotic system may use particular sensors for purposes not enumerated herein.

The robotic system 100 may also include one or more power source(s) 114 configured to supply power to various components of the robotic system 100. Among other possible power systems, the robotic system 100 may include a hydraulic system, electrical system, batteries, and/or other types of power systems. As an example illustration, the robotic system 100 may include one or more batteries configured to provide charge to components of the robotic system 100. Some of the mechanical components 110 and/or electrical components 116 may each connect to a different power source, may be powered by the same power source, or be powered by multiple power sources.

Any type of power source may be used to power the robotic system 100, such as electrical power or a gasoline engine. Additionally or alternatively, the robotic system 100 may include a hydraulic system configured to provide power to the mechanical components 110 using fluid power. The power source(s) 114 may charge using various types of charging, such as wired connections to an outside power source, wireless charging, combustion, or other examples.

The electrical components 116 may include various mechanisms capable of processing, transferring, and/or providing electrical charge or electric signals. Among possible examples, the electrical components 116 may include electrical wires, circuitry, and/or wireless communication transmitters and receivers to enable operations of the robotic system 100. The electrical components 116 may interwork with the mechanical components 110 to enable the robotic system 100 to perform various operations. The electrical components 116 may be configured to provide power from the power source(s) 114 to the various mechanical components 110, for example. Further, the robotic system 100 may include electric motors. Other examples of electrical components 116 may exist as well.

Although not shown in FIG. 1, the robotic system 100 may include a body, which may connect to or house appendages and components of the robotic system. As such, the structure of the body may vary within examples and may further depend on particular operations that a given robot may have been designed to perform. For example, a robot developed to carry heavy loads may have a wide body that enables placement of the load. Similarly, a robot designed to reach high speeds may have a narrow, small body that does not have substantial weight. Further, the body and/or the other components may be developed using various types of materials, such as metals or plastics. Within other examples, a robot may have a body with a different structure or made of various types of materials.

The body and/or the other components may include or carry the sensor(s) 112. These sensors may be positioned in various locations on the robotic system 100, such as on the body and/or on one or more of the appendages, among other examples. On its body, the robotic system 100 may carry a load, such as a type of cargo that is to be transported. The load may also represent external batteries or other types of power sources (e.g., solar panels) that the robotic system 100 may utilize. Carrying the load represents one example use for which the robotic system 100 may be configured, but the robotic system 100 may be configured to perform other operations as well.

As noted above, the robotic system 100 may include various types of legs, arms, wheels, and so on. In general, the robotic system 100 may be configured with zero or more legs. An implementation of the robotic system with zero legs may include wheels, treads, or some other form of locomotion. An implementation of the robotic system with two legs may be referred to as a biped, and an implementation with four legs may be referred as a quadruped. Implementations with six or eight legs are also possible. For purposes of illustration, biped and quadruped implementations of the robotic system 100 are described below.

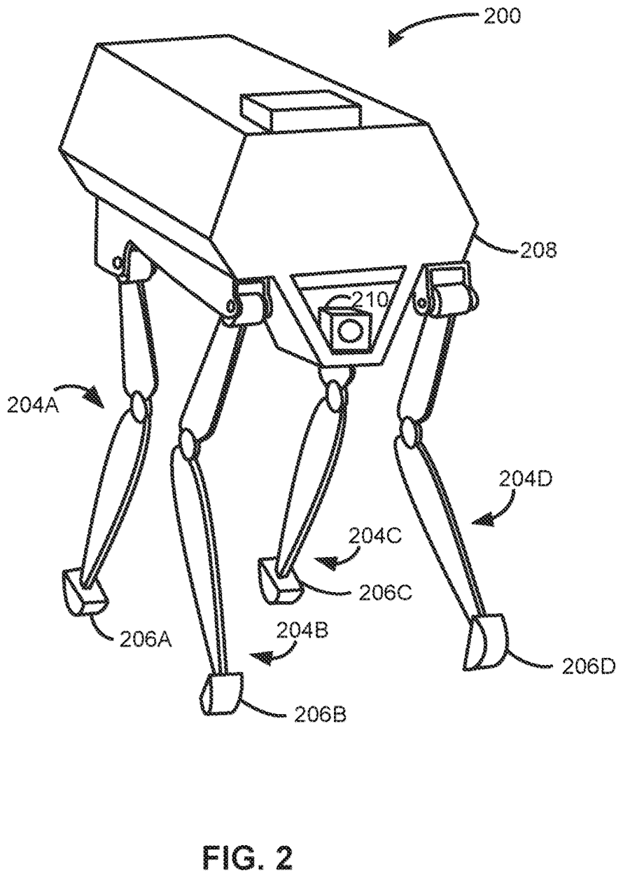

FIG. 2 illustrates a quadruped robot 200, according to an example implementation. Among other possible features, the robot 200 may be configured to perform some of the operations described herein. The robot 200 includes a control system, and legs 204A, 204B, 204C, 204D connected to a body 208. Each leg may include a respective foot 206A, 206B, 206C, 206D that may contact a surface (e.g., a ground surface). Further, the robot 200 is illustrated with sensor(s) 210, and may be capable of carrying a load on the body 208. Within other examples, the robot 200 may include more or fewer components, and thus may include components not shown in FIG. 2.

The robot 200 may be a physical representation of the robotic system 100 shown in FIG. 1, or may be based on other configurations. Thus, the robot 200 may include one or more of mechanical components 110, sensor(s) 112, power source(s) 114, electrical components 116, and/or control system 118, among other possible components or systems. The configuration, position, and/or structure of the legs 204A-204D may vary in example implementations. The legs 204A-204D enable the robot 200 to move relative to its environment, and may be configured to operate in multiple degrees of freedom to enable different techniques of travel. In particular, the legs 204A-204D may enable the robot 200 to travel at various speeds according to the mechanics set forth within different gaits. The robot 200 may use one or more gaits to travel within an environment, which may involve selecting a gait based on speed, terrain, the need to maneuver, and/or energy efficiency.

Further, different types of robots may use different gaits due to variations in design. Although some gaits may have specific names (e.g., walk, trot, run, bound, gallop, etc.), the distinctions between gaits may overlap. The gaits may be classified based on footfall patterns—the locations on a surface for the placement the feet 206A-206D. Similarly, gaits may also be classified based on ambulatory mechanics.

The body 208 of the robot 200 connects to the legs 204A-204D and may house various components of the robot 200. For example, the body 208 may include or carry sensor(s) 210. These sensors may be any of the sensors discussed in the context of sensor(s) 112, such as a camera, LIDAR, or an infrared sensor. Further, the locations of sensor(s) 210 are not limited to those illustrated in FIG. 2. Thus, sensor(s) 210 may be positioned in various locations on the robot 200, such as on the body 208 and/or on one or more of the legs 204A-204D, among other examples.

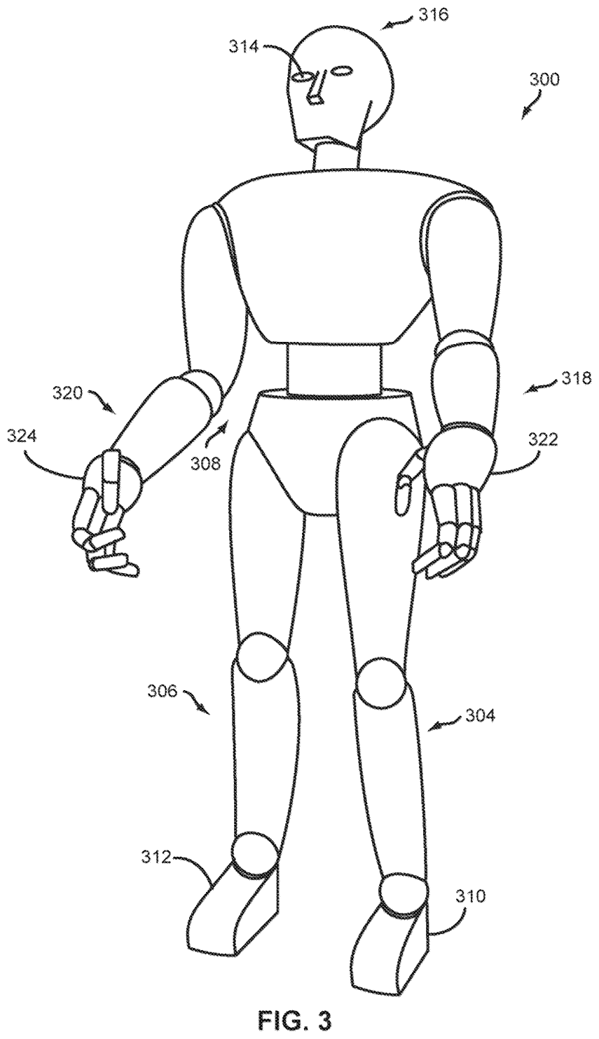

FIG. 3 illustrates a biped robot 300 according to another example implementation. Similar to robot 200, the robot 300 may correspond to the robotic system 100 shown in FIG. 1, and may be configured to perform some of the implementations described herein. Thus, like the robot 200, the robot 300 may include one or more of mechanical components 110, sensor(s) 112, power source(s) 114, electrical components 116, and/or control system 118.

For example, the robot 300 may include legs 304 and 306 connected to a body 308. Each leg may consist of one or more members connected by joints and configured to operate with various degrees of freedom with respect to one another. Each leg may also include a respective foot 310 and 312, which may contact a surface (e.g., the ground surface). Like the robot 200, the legs 304 and 306 may enable the robot 300 to travel at various speeds according to the mechanics set forth within gaits. The robot 300, however, may utilize different gaits from that of the robot 200, due at least in part to the differences between biped and quadruped capabilities.

The robot 300 may also include arms 318 and 320. These arms may facilitate object manipulation, load carrying, and/or balancing for the robot 300. Like legs 304 and 306, each arm may consist of one or more members connected by joints and configured to operate with various degrees of freedom with respect to one another. Each arm may also include a respective hand 322 and 324. The robot 300 may use hands 322 and 324 (or end-effectors) for gripping, turning, pulling, and/or pushing objects. The hands 322 and 324 may include various types of appendages or attachments, such as fingers, grippers, welding tools, cutting tools, and so on.

The robot 300 may also include sensor(s) 314, corresponding to sensor(s) 112, and configured to provide sensor data to its control system. In some cases, the locations of these sensors may be chosen in order to suggest an anthropomorphic structure of the robot 300. Thus, as illustrated in FIG. 3, the robot 300 may contain vision sensors (e.g., cameras, infrared sensors, object sensors, range sensors, etc.) within its head 316.

### II. Example Electromechanical Actuators and Robots Utilizing Them

In examples, hydraulic actuators could be used to actuate members of a robot. A hydraulic system may include a pump and accumulator at a central location on the robot and be configured to provide pressurized hydraulic fluid through pipes and/or hoses to hydraulic actuators coupled to the members of the robot. In this configuration, the actuation inertia of the pump and accumulator is decoupled from inertia provided to the ground surface as the robot moves. Due to the decoupling of inertias, hydraulic robotic systems are characterized by high bandwidth for position and force control responsiveness. However, hydraulic systems have disadvantages such as potential hydraulic fluid leaks, complexity of plumbing, and unsuitability of existing hydraulic power units to smaller robots.

Electromechanical actuators alleviate at least some disadvantages of hydraulic actuators because there are no leaks or complex plumbing involved with operating electromechanical actuators. Further, electromechanical systems may be more efficient than hydraulic systems. However, electromechanical actuators may have disadvantages compared to hydraulic systems. For instance, while the rotating inertia of a robot member driven by a hydraulic actuator might have a linear relationship with a diameter of the actuator for a given strength, the rotating inertia of a robot member driven by an electromechanical actuator may be proportional to the square of the diameter of the actuator's rotating assembly and is influenced by the gear ratio of the transmission for the given strength. Further, reflected inertia of a hydraulic actuator might be negligible compared to the inertia of a member (e.g., leg) of a robot, whereas reflected inertia of an electromechanical actuator may depend on inertias of the motor and the transmission multiplied by the square of the gear ratio of the transmission. Thus, for large robots, electromechanical actuators may have a high inertia that limits responsiveness and performance characteristics of the robot. For robots smaller in size, electromechanical actuators could be designed to achieve high performance characteristics compared to corresponding hydraulic actuators.

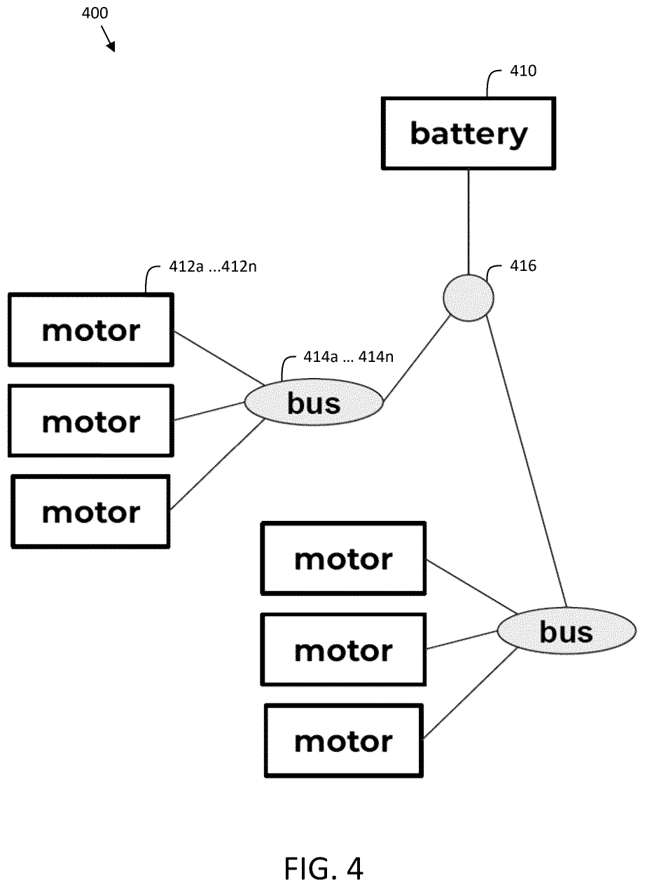

FIG. 4 schematically illustrates a power system 400 of a robot having electromechanical actuators (also referred to herein as “electric motors” or simply “motors”), in accordance with some embodiments of the present disclosure. Power system 400 includes a power source 410 (e.g., one or more batteries) configured to produce power (e.g., electric power) based on stored energy. Power (or alternatively, current or voltage) may be requested from one or more controllers associated with a plurality of motors 412a . . . 412n of the robot. The requested power may be provided from the power source 410 to one or more of the plurality of motors 412a . . . 412n via one or more power buses 414a . . . 414n to move one or more joints of the robots with which the motor(s) are associated to perform a desired behavior (e.g., positive work). As shown, the one or more power busses 414a . . . 414n may be electrically coupled to the power source 410 via electrical circuitry 416. In some embodiments, regenerative power may be produced due to negative work performed by the robot (e.g., landing on the floor after jumping off of a table), and the regenerative power may be used, at least in part, to recharge the power source 410. In some embodiments, excess regenerative power may be discharged in one or more components of the robot (e.g., in the form of heat).

The power buses 414a . . . 414n may have an upper limit that reflects the maximum power that can be drawn from the power source 410 before the bus “browns out,” and a lower limit that represents the point beyond which it is no longer safe to charge the power source 410 (e.g., with regenerative power). Some embodiments include sensors to measure the voltage of the power buses 414a . . . 414n to transform the upper and lower power limits of the power buses 414a . . . 414n into limits on the current on the buses. The bus current limits can then be included as power limit information to determine a control strategy for the robot, as described in more detail below.

Some components of the electric power system of a robot may be associated with minimum operating voltages. For instance, field effect transistors (FETs) used as switches in the electric control circuitry of the robot may require a minimum operating voltages. Resistive losses at high (positive) power may result in large voltage drops in the electric power system of the robot. When the voltage is lowered (e.g., across several joints), the minimum operating voltages (e.g., of the FETs) may not be met, resulting in the FETs turning off and causing the torque to the motor associated with the turned off FETs to drop to zero. Some embodiments of the present disclosure take into account such limits in an effort to prevent such behavior and/or to maintain performance of the robot when it may be necessary to approach such limits to achieve a desired robot behavior.

The inventors have recognized and appreciated that in an electric power system, such as power system 400 shown in FIG. 4, the various components including power source 410, motors 412a . . . 412n, and power bus(es) 414a . . . 414n may be highly integrated, such that all or a subset of the controllers for motors 412a . . . 412n may simultaneously request power from power source 410, which may exceed the capabilities of the power source 410 to satisfy such requests. Additionally, an amount of regenerative power produced by components of the robot may exceed charging limits of the power source 410, resulting in damage to the electrical components of the power system 400 if the total regenerative power was used to charge the power source 410. To this end, some embodiments of the present disclosure relate to techniques for managing power in a robotic device that take into account the various limits of the robot's power system components including limits of the individual motors 412a . . . 412n and the overall power budget of the power source 410. As described in further detail below, some embodiments account for such power limits during the computation of motor control information (e.g., motor torques) that is used to control a plurality of motors (e.g., motors 412a . . . 412n) associated with a plurality of joints of the robot. By intelligently trading off power provided to motors associated with various joints, the robot may be able to perform particular movements within the power budget of the robot that may not be possible using conventional approaches that reduce (e.g., uniformly reduce) the power provided to all motors of the robot when the total requested power exceeds the power budget of the power system.

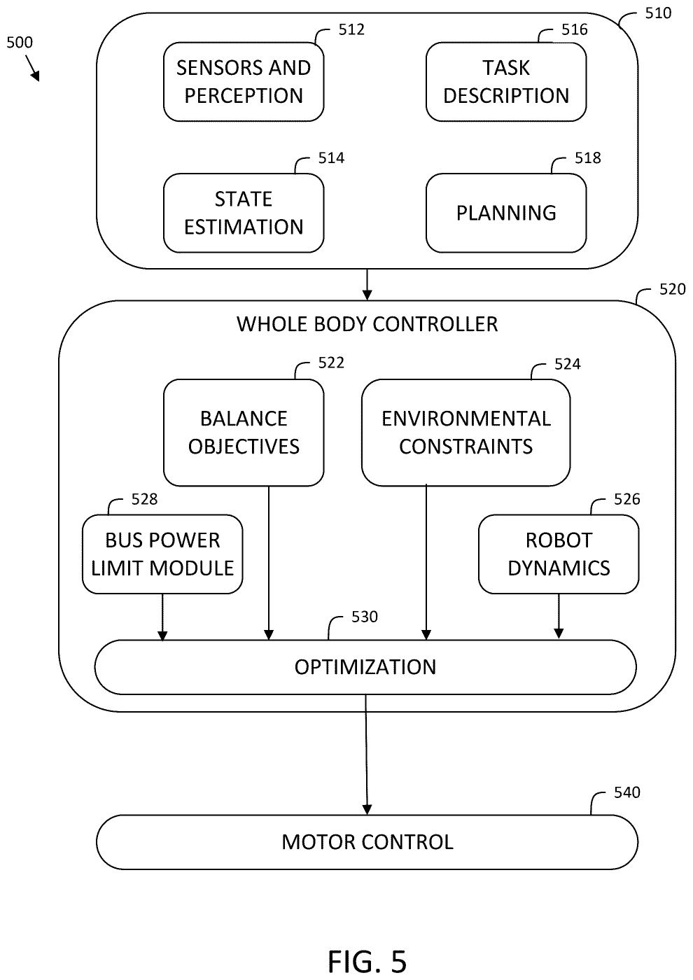

FIG. 5 is a schematic representation of an architecture 500 for a control system of a robot, in accordance with some embodiments of the present disclosure. Architecture 500 includes input modules 510 and whole body controller 520, which is configured to output motor control information based, at least in part, on information from input modules 510 and a plurality of objectives and/or constraints associated with the robot. For example, in some embodiments whole body controller 520 may be configured to determine control parameters (e.g. joint torques, limb trajectories, etc.) for the robot based, at least in part, on a representation of the joints and/or links of the robot. The granularity of the representation of joints/links of the robot may differ in particular implementations. For instance, in some implementations, the representation may include a description of all of the joints/links of the robot. In other implementations, the representation may include a description of a subset of all of the joints of the joints/links of the robot, wherein the subset is sufficient describe the whole body posture and/or motion of the robot.

As shown in FIG. 5, input modules 510 may include modules configured to determine information about the current state of the robot and/or the robot's environment, a task that the robot is instructed to perform, and how the robot may move to perform the task. For example, input modules 510 includes sensors and perception module 512, which enables the robot to detect and/or identify objects (e.g., stationary objects such as walls, other robots, humans, etc.) in the environment of the robot. Information from sensors and perception module 512 may be used, for example, to facilitate interaction between the robot and one or more objects in the environment, such as grasping an object, avoiding collisions with an object when performing a movement of at least a portion of the robot, etc.

Input modules 510 may further include state estimation module 514, which may be configured to determine a current state (e.g., a current pose) of at least a portion of the robot. For instance, state estimation module 514 may be configured to determine the current pose of a robot base, a robot arm, an end effector of the robot, etc. Input modules 510 may further include task description module 516 configured to provide details of a task to be performed by the robot. For instance, task description module 516 may be configured to provide a high-level description of the task (e.g., grasping and/or moving an object in the environment, performing a coordinated movement such as a dance routine or backflip, opening a door, etc.). Input modules 510 may further include planning module 518, which may be configured to plan a series of movements of the robot to perform a desired task (e.g., a task provided by the task description module 516). For instance, planning module 518 may be configured to use information about the current state of at least a portion of the robot (e.g., determined by state estimation module 514), information about the environment of the robot (e.g., determined by sensors and perception module 512), and information about a task to be performed (e.g., determined by task description module 516) to plan movements of the robot (e.g., moving one or more joints of the robot from its current state to a goal state over time) to perform the task.

Whole body controller 520 may be configured to model the dynamics of the robot including all, or substantially all, of the linkages and joints of the robots and to determine a control strategy for actuating the joints of the robot to perform a particular task. In some embodiments, the control strategy may be represented as motor control information describing how to control motors associated with the plurality of joints of the robot. For instance, the motor control information may include a set of motor torques to be applied at some or all of the motors associated with the plurality of joints of the robot to achieve a desired behavior of the robot.

In some embodiments, the control strategy may be determined by performing an optimization (e.g., a nonlinear optimization) based on various objectives and subject to certain constraints. Example objectives include, but are not limited to, balance objectives 522 for the robot (e.g., ensuring that the feet of the robot don't slip), force objectives (e.g., provide as much downward force on the ground as possible), and speed objectives (e.g. moving a portion of the robot quickly/slowly). Each of the objectives may be associated with a cost, and prioritization of the objectives may be implemented by adjusting the cost associated with a particular objective relative to costs associated with other objectives. For instance, the inventors have recognized that maintaining the balance of the robot may be particularly important to ensure that the robot can perform a desired behavior. Accordingly, balance objectives may be associated with a larger cost (higher priority) relative to other objectives to prioritize maintaining the balance of the robot during movements of the robot. In some embodiments, the highest priorities when determining a control strategy for the robot may include obeying individual actuator limits, obeying total power system limits, and maintaining balance of the robot (e.g., by not slipping the feet of the robot). In some embodiments, the costs associated with the objectives may be set based, at least in part, on simulation and/or hardware experiments in which different robot behaviors are tested.

Constraints may include physics-based limitations that the robot's environment or components of the robot impose on the control strategy. For instance, environmental constraints 524 include physics-based constraints of the environment (e.g., friction) that limit the amount of force the robot can produce on the ground. Additionally, the individual components of the robot (e.g., the motors of the robot) may be associated with various constraints (e.g., voltage limits, temperature limits, current limits) that may impact the control strategy. For example, the change in temperature of a motor may be related to the resistive heating of the motor windings and convective cooling to the environment. Providing additional current to a motor that is already hot may result in reduced motor performance, and such temperature limits may be taken into account when determining the control strategy. Additionally, electric motors have torque and current limits, which may be considered when determining the control strategy. Robot dynamics 526 may impose additional constraints that may impact the control strategy. For instance, the robot may include various types of joints with different degrees of freedom and/or ranges of motion. In some embodiments, each of the joints of the robot may be associated with a cost for producing a requested force, and the control strategy may be optimized to minimize the costs across the plurality of joints while still achieving the desired behavior.

As described herein, the inventors have recognized and appreciated that including power limit constraints in the control strategy determination may facilitate an intelligent tradeoff of power provided to actuators associated with certain joints relative to other joints that may be important to achieve a desired behavior. For instance, when the task is for the robot to jump as high as possible, power requested by the elbow and/or wrist joints of the robot may instead be provided to the hip and knee joints of the robot to achieve the desired behavior while staying within the overall power budget of the robot. In some embodiments, whole-body controller 520 may include bus power limit module 528, which may be configured to represent power limit information as a constraint in the determination of the control strategy. The power limit information may include, for example, information about the total power that a power source can provide on the power bus, information about the amount of regenerative power that can be used for charging the power source, voltage limits associated with the power source, and/or current limits associated with the power source. By considering the overall power budget of the robot when determining a control strategy, the available power provided to particular motors may be increased (e.g., maximized) without damaging the electrical components of the robot.

As described above, in some embodiments, the whole body controller 520 is configured to determine a strategy by performing an optimization (e.g., a nonlinear optimization) that balances the objectives and is subject to various constraints including power limit constraints, examples of which are provided herein. To this end, whole body controller 520 may include optimization engine 530 configured to perform the optimization based on the objectives and constraints specified by the different modules included in the whole body controller 520. The output of the optimization may be motor control information 540, which may be used to control the plurality of motors associated with the joints of the robot. For instance, the motor control information 540 may include one or more joint torques, motor currents, forces, etc. that may be determined by optimization engine 530 subject to robot dynamics, total power limits and other constraints considered by the whole body controller 520.

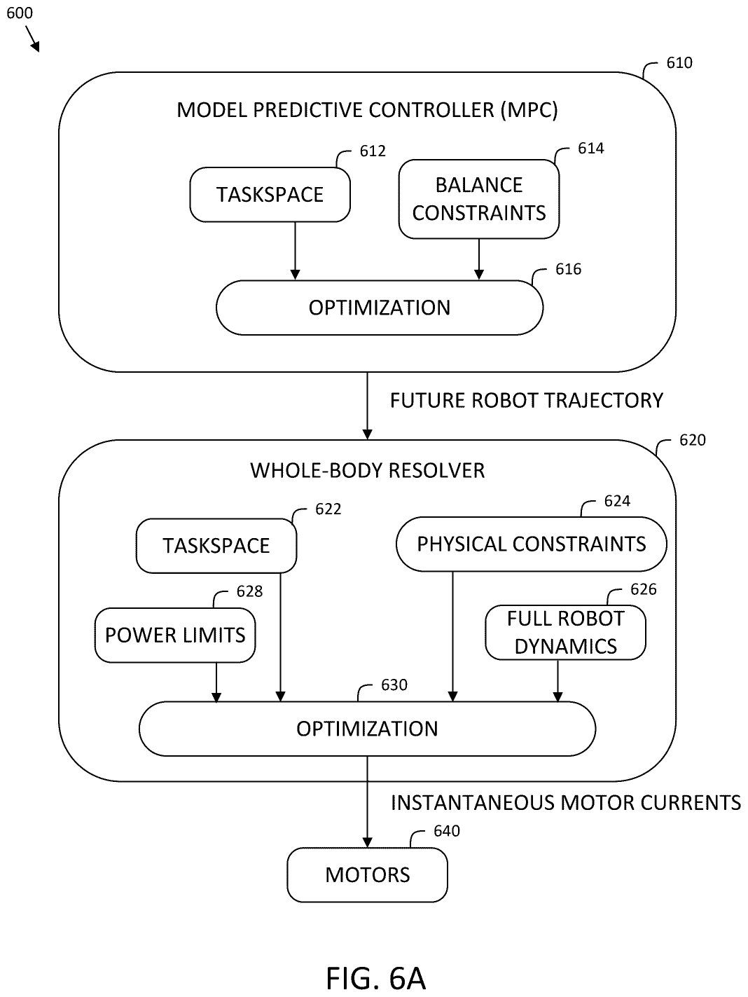

In some embodiments, whole body controller 520 may be implemented using a multi-stage control architecture that includes a model predictive controller (MPC) configured to determine robot trajectories over a future time horizon (e.g., 1-2 seconds) and a whole-body resolver configured to determine instantaneous (or near instantaneous) motor command information (e.g., motor currents) used to control the plurality of motors associated with the plurality of joints of the robot. A first example implementation of a multi-stage control architecture 600 in accordance with some embodiments is shown in FIG. 6A. As shown, architecture 600 includes model predictive controller (MPC) 610 and whole-body resolver 620. MPC 610 may be configured to determine the forces that the robot should apply on its environment (e.g., how hard the feet should push on the ground) and also how the joints of the robot should move (e.g., joint accelerations) over the immediate short term future (e.g., 1-2 seconds), collectively referred to herein as the future robot trajectory. Whole-body resolver 620 may be configured to transform the forces and joint motions in the future robot trajectory into wrenches (e.g., forces and torques) for the plurality of joints of the robot (e.g., how hard each individual joint should push to achieve the forces and motions specified in the future trajectory). For example, whole-body resolver 620 may be implemented as an inverse dynamics solver configured to output a plurality of torques for a robot based, at least in part, on the future trajectory output from the MPC 610. The motor control information (e.g., plurality of torques) may be converted into motor commands for controlling motors 640 of the robot.

In some embodiments, the MPC 610 may be configured to perform a first optimization to determine the future robot trajectory and the whole-body resolver 620 may be configured to perform a second optimization to determine the motor control information based on the future robot trajectory output from the first optimization. The first and second optimizations may consider different objectives and/or be subject to different constraints. For instance, as shown in architecture 600, MPC 610 may be configured to perform a first optimization using first optimization engine 616 to determine a future robot trajectory. The first optimization may take into consideration a task objective 612 relating to a task to be performed by the robot. Determination of the future robot trajectory as output from the first optimization may be subject to balance constraints 614, which may be informed by a model of the robot dynamics.

Whole-body resolver 620 may be configured to perform a second optimization using second optimization engine 630 to determine motor command information (e.g., instantaneous motor currents). The second optimization may take into consideration a task objective 622 relating to a task to be performed by the robot. Determination of the motor control information as output from the second optimization may be subject to physical constraints 624 (e.g., physical constraints of robot components, physical constraints of the robot's environment, etc.), which may be informed by a model of the robot dynamics 626. In some embodiments, the model of robot dynamics 626 used by the whole-body resolver 620 to perform the second optimization may be different than the model of robot dynamics used by the MPC 610 to perform the first optimization. For example, the model of robot dynamics 626 may include a more accurate physics model of the robot dynamics compared to the model of robotic dynamics used by the MPC 610. Use of a more accurate physics model in the whole-body resolver 620 may facilitate the ability of the whole-body resolver 620 to trade off costs associated with joints of the robot to perform a desired behavior. As shown in architecture 600, the second optimization performed by optimization engine 630 may be constrained, at least in part, based on power limit information 628. As described herein, power limit information 628 may include, but is not limited to, limits on the total available power to be provided from a power source of the robot, limits on the total regenerative power that can be used for charging a power source of the robot, power limits for individual motors of the robot, and/or power limits associated with currents and/or voltages that could cause damage to electrical components of the robot if exceeded (e.g., bus power limits). By considering power limit information 628 when performing the second optimization, a control strategy may be determined by the optimization engine 630, which maximizes the available energy at motors needed to achieve a desired behavior while lowering the risk of damaging electrical components of the robot.

A second example implementation of a multi-stage control architecture 650 in accordance with some embodiments is shown in FIG. 6B. Architecture 650 includes components similar to architecture 600 shown in FIG. 6A with the addition that the first optimization performed by optimization engine 616 of the MPC 610 also takes into consideration power limit information 613 as a constraint in the optimization. That is, in architecture 650 the determination of the future robot trajectory as output by the first optimization performed by optimization engine 616 is constrained based on power limit information 613 to produce a power efficient trajectory (e.g., swinging a robot arm in a power-efficient way to perform a task objective). By constraining the first optimization performed by optimization engine 616 based on the power limit information 613, the optimization process may be able to trade off power provided to different joints over time, which may not be possible if power limit information is only used as a constraint when determining instantaneous motor command information (e.g., as part of a second optimization in the whole-body resolver 620). Accordingly, considering power limit information in both the first and second optimizations may enable additional flexibility in how the power limits can be satisfied when determining a control strategy to perform a desired behavior. It should be appreciated that the power limit information considered in the first and second optimizations may include the same power limit information or may include different power limit information. In a third example implementation (not shown), the power limit information may only be considered in the first optimization performed by the MPC 610 and not by the second optimization performed by the whole-body resolver 620.

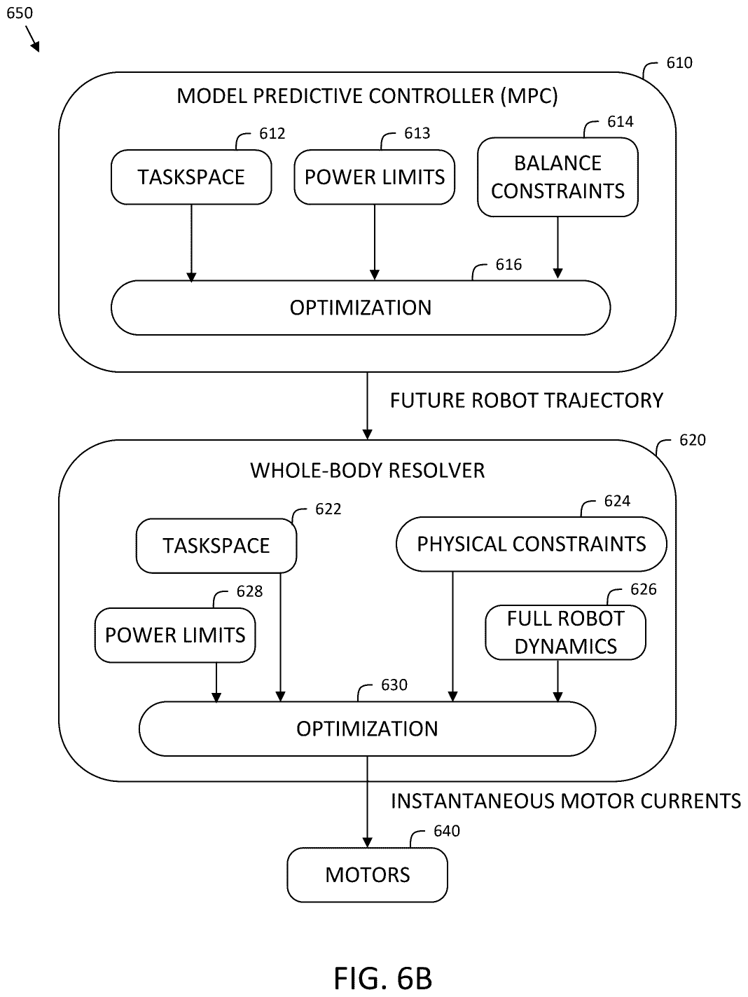

FIG. 7 is a flowchart of a process 700 for determining a control strategy for a robot based, at least, in part, on power limit information, in accordance with some embodiments of the present disclosure. Process 700 begins in act 710, where motor control information (e.g., instantaneous motor currents for each of a plurality of motors associated with a plurality of joints) is determined based, at least in part, on a future robot trajectory to achieve a desired behavior and power limit information associated with a power system of the robot. As described herein, in some embodiments, the future robot trajectory may be determined by an MPC over a time horizon (e.g., a time horizon of 1-2 seconds) and the motor control information may include instantaneous (or near instantaneous) motor currents for each of a plurality of motors associated with a plurality of joints of the robot determined by a whole-body resolver. The power limit information may include system-level power information (e.g., how much power can be discharged from the battery system, how much power can be used to charge the battery system, bus power limits, etc.) and/or power information for individual electrical components of the system (e.g., individual electric motors). In some embodiments, the power limit information may be used, at least in part, to determine the robot trajectory (e.g., using architecture 650). In other embodiments, the determination of the robot trajectory may not be constrained using the power limit information, and the power limit information may be used to determine the motor control information following determination of the robot trajectory (e.g., using architecture 600). Process 700 may then proceed to act 720, where a plurality of motors associated with a plurality of joints of the robot may be controlled based on the motor control information. For instance, the motor control information may include motor commands that may be sent to individual motor controllers of the robot to provide a particular amount of motor current from the power bus to a set of motors that may be actuated to enable the robot to perform a desired behavior (e.g., jumping, grasping an object, etc.). By taking power limits into consideration when determining the motor control information, the available power can be distributed to the motors in a manner that improves the chances of the robot to successfully perform the desired behavior.

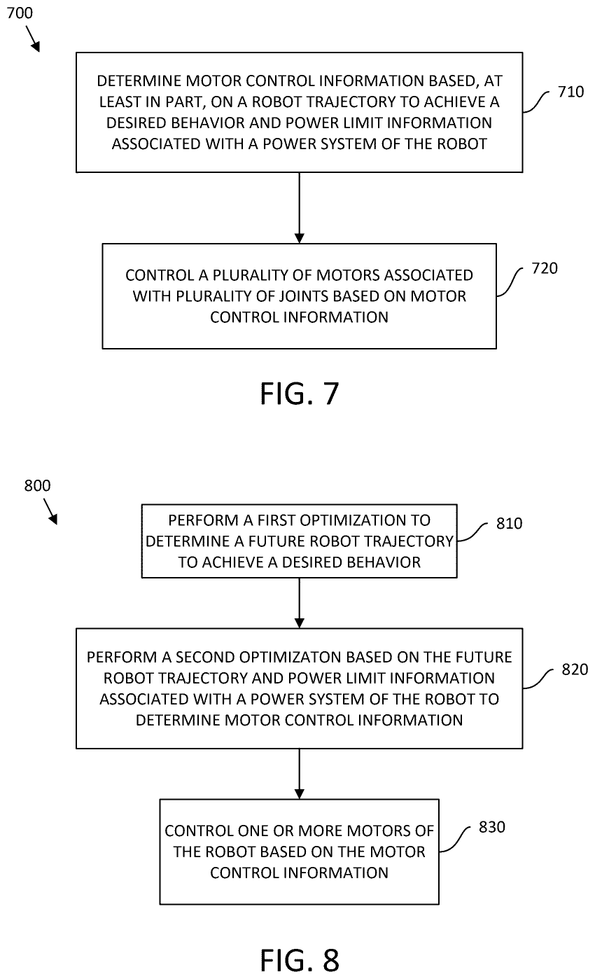

FIG. 8 is a flowchart of a process 800 for determining a control strategy for a robot using a multi-level architecture, the control strategy being determined based, at least in part, on power limit information, in accordance with some embodiments of the present disclosure. Process 800 begins in act 810, where a first optimization is performed to determine a future (i.e., forward-looking) robot trajectory to achieve a desired behavior. For instance, a controller of the robot may include a first component (e.g., MPC 610 in architecture 600) configured to perform the first optimization to determine the future robot trajectory based on task information and one or more constraints (e.g., balance constraints, robotic dynamics constraints, etc.). In some embodiments, the future robot trajectory may include wrenches (e.g., forces and torques) that the robot should apply on its environment and accelerations of the plurality of the joints of the robots to achieve the desired behavior.

Process 800 then proceeds to act 820, where a second optimization is performed based on the future robot trajectory determined in act 810 and power limit information associated with a power system of the robot to determine motor control information. For instance, a controller of the robot may include a second component (e.g., whole-body resolver 620 in architecture 600) configured to perform the second optimization to determine the motor control information. In some embodiments, the output of the second optimization may be a plurality of torques that may be transformed into motor commands to send motor currents to a plurality of motors associated with the plurality of joints of the robot. The second optimization may be performed based, at least part, on a model of robot dynamics that describes the relationship between torques on each joint, forces on the robot's environment and accelerations of the joints. In some embodiments, at least some of the information in the future robot trajectory (e.g., forces to be applied to the robot's environment) may be changed when performing the second optimization to enable the robot to perform a behavior slightly different than the originally specified behavior. The power limit information may be used as a constraint in the second optimization to ensure that the output motor control information (e.g., a set of joint torques, instantaneous motor current, etc.) satisfies the power limits of the robot. The power limit information may include system-level power information (e.g., how much power can be discharged from the battery system, how much power can be used to charge the battery system, bus power limits, etc.) and/or power information for individual electrical components of the system (e.g., individual electric motors).

Process 800 may then proceed to act 820, where a plurality of motors associated with a plurality of joints of the robot may be controlled based on the motor control information. For instance, the motor control information may include motor commands to provide a particular amount of motor current from the power bus to a set of motors that may be actuated to enable the robot to perform a desired behavior (e.g., jumping, grasping an object, etc.). By taking power limits into consideration when determining the motor control information, the available power can be distributed to the motors in a manner that improves the chances of the robot to successfully perform the desired behavior.

When a robot performs particular behaviors (e.g., jumping off of a table onto the floor, changing directions rapidly with a heavy load, etc.), a large amount of kinetic energy is transformed into potential energy (also referred to herein as “regenerative energy” or “regenerative power”) in an electric motor (e.g., through electric motor resistance) that can be used to charge the power source (e.g., one or more batteries) of the robot. However, the amount of regenerative power that can be created in such a scenario may exceed the charging limits of the power source. In such instances, the regenerative power may be dissipated (e.g., as heat) to prevent damage to electronic components of the robot. For instance, a large resistor and/or diode network may be included as a component of the robot to dissipate regenerative power.

The inventors have recognized and appreciated that including a large resistor and/or diode network in a robot for the sole purpose of dissipating regenerative power caused by negative work may not be necessary if the regenerative power can be dissipated in other ways using existing components of the robot. To this end, the inventors have recognized that the techniques described herein for determining a control strategy for intelligently distributing available power from a power system to a particular set of joints to achieve a desired robot behavior (e.g., to perform “positive work”), may also be used to determine how to handle regenerative power generated when the robot performs “negative work,” as described above. For instance, the power limit information used to determine motor control information for controlling the motors of the robot may include information on the charging limits of the power source, and when regenerative power is generated due to the performance of negative work, the regenerative power may be intelligently distributed to components of the robot for dissipation in ways that may not affect the robot's ability to perform a desired behavior.

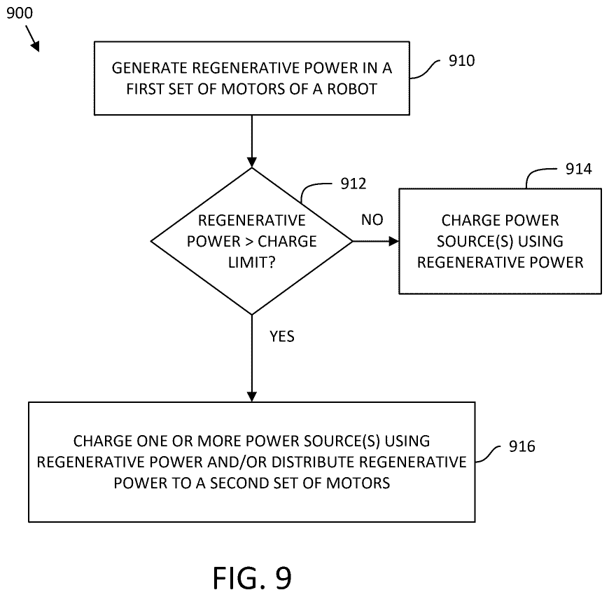

FIG. 9 is a flowchart of a process 900 for managing regenerative power generated by a robot, in accordance with some embodiments of the present disclosure. In act 910, regenerative power is generated in a first set of motors of a robot as the robot performs negative work. For instance, when the robot jumps off of a table onto the ground, regenerative power may be generated in a set of motors associated with the ankle, knee and hip joints of the robot. Process 900 then proceeds to act 912, where it is determined whether the amount of regenerative power exceeds a the charge limit of the power source(s) of the robot. If it is determined that the amount of regenerative power does not exceed the charge limit of the power source(s) of the robot, process 900 may proceed to act 914, where the regenerative power is used to charge the power source(s) of the robot. Alternatively, if it is determined in act 912 that the amount of regenerative power exceeds the charge limit of the power source(s) of the robot, process 900 may proceed to act 916, where at least a first portion of the regenerative power may be used to charge the power source(s) of the robot and/or at least a second portion of the regenerative power may be distributed to a second set of motors for dissipation.

In some embodiments, the second set of motors used for dissipation of regenerative energy may be selected as part of a control strategy for controlling the motors of the robot to perform a desired behavior, in accordance with the techniques described herein. For instance, because the plurality of electric motors are coupled via a power bus, regenerative power generated in one portion of the robot (e.g., a motor in the knee) may be instantaneously routed to another portion of the robot (e.g., a motor in the shoulder) that is otherwise not being used to perform a desired behavior. In this way, a control strategy that takes into account regenerative power that will be produced by performance of a desired behavior may be able to intelligently route the regenerative power for charging and/or dissipation without affecting the robot's ability to successfully perform the desired behavior.

In some embodiments, the power limits related to charging the power source(s) of the robot may be used by the control system (e.g., having architecture 600 or architecture 650) to determine a set of motor control parameters (e.g., instantaneous motor currents) that satisfies a desired regenerative energy profile when performing the desired behavior. For instance, the control system may be configured to select joint torques for the plurality of joints to perform the desired behavior that also minimizes (or maximizes or provides within limits) the regenerative power expected to be generated by performing a desired behavior. In this way, the robot may be intelligently controlled to perform behaviors that satisfy power limits of the robot when performing both positive and negative work.

A number of implementations have been described. Nevertheless, it will be understood that various modifications may be made without departing from the spirit and scope of the disclosure.

1. A controller for a robot, the robot including a plurality of joints, the controller programmed to execute a plurality of instructions that, when executed by a processor of a computing device perform a method comprising:
determining, by the computing device, motor control information for a plurality of motors associated with the plurality of joints, the motor control information being based, at least in part, on a robot trajectory to achieve a desired behavior and power limit information associated with a power system of the robot; and
controlling the plurality of motors associated with the plurality of joints of the robot based, at least in part, on the motor control information.

2. The controller of claim 1, wherein the method further comprises:
receiving the robot trajectory, wherein determining the motor control information comprises performing an optimization based on the robot trajectory, wherein the optimization includes a power limit constraint based on the power limit information.

3. The controller of claim 2, wherein performing an optimization includes minimizing a cost function associated with at least one objective, wherein minimizing the cost function is subject to one or more constraints including the power limit constraint.

4. The controller of claim 3, wherein the at least one objective includes a balance objective for the robot.

5. The controller of claim 3, wherein the one or more constraints includes limits of each of the plurality of motors.

6. The controller of claim 3, wherein the one or more constraints includes environmental constraints.

7. The controller of claim 1, wherein the motor control information includes instantaneous motor currents for each of the plurality of motors.

8. The controller of claim 1, wherein determining motor control information comprises determining a plurality of joint torques for the plurality of joints.

9. The controller of claim 1, wherein the method further comprises:
determining based, at least in part, on the power limit information associated with a power system of the robot, the robot trajectory.

10. The controller of claim 9, wherein determining the motor control information comprises performing an optimization based on the robot trajectory, wherein the optimization includes a power limit constraint based on the power limit information.

11. The controller of claim 1, wherein the robot trajectory includes a plurality of forces that the robot should apply on its environment to achieve the desired behavior, and a plurality of accelerations for the plurality of joints.

12. The controller of claim 1, wherein the controller is a whole-body controller and the plurality of joints include each joint of the robot that is associated with one or more of the plurality of motors.

13. The controller of claim 1, wherein the power system of the robot is an electric power system including at least one battery, and the motor control information includes motor currents for each of the plurality of motors.

14. The controller of claim 13, wherein the power limit information includes power that can be provided by the at least one battery and/or power that can be consumed by the at least one battery during recharging of the at least one battery.

15. A robot comprising:
a plurality of joints;
a plurality of motors associated with the plurality of joints;
a power system configured to provide power to the plurality of motors;
data processing hardware; and
memory hardware in communication with the data processing hardware, the memory hardware storing instructions that when executed on the data processing hardware cause the data processing hardware to perform operations comprising:
determining motor control information for the plurality of motors associated with the plurality of joints, the motor control information being based, at least in part, on a robot trajectory to achieve a desired behavior and power limit information associated with the power system of the robot; and
controlling the plurality of motors associated with the plurality of joints of the robot based, at least in part, on the motor control information.

16. The robot of claim 15, wherein the operations further comprise:
receiving the robot trajectory, wherein determining the motor control information comprises performing an optimization based on the robot trajectory, wherein the optimization includes a power limit constraint based on the power limit information.

17. The robot of claim 15, wherein the power system is an electric power system including at least one battery, and the motor control information includes motor currents for each of the plurality of motors.

18. The robot of claim 17, wherein the power limit information includes power that can be provided by the at least one battery and/or power that can be consumed by the at least one battery during recharging of the at least one battery.

19. A computer-implemented method, comprising:
determining, by a computing system of a robot, motor control information for a plurality of motors associated with a plurality of joints the robot, the motor control information being based, at least in part, on a robot trajectory to achieve a desired behavior and power limit information associated with a power system of the robot; and
controlling the plurality of motors associated with the plurality of joints of the robot based, at least in part, on the motor control information.

20. The method of claim 19, further comprising:
receiving the robot trajectory, wherein determining the motor control information comprises performing an optimization based on the robot trajectory, wherein the optimization includes a power limit constraint based on the power limit information.
